(19) United States
(12) Patent Application Publication
(10) Pub. No.: US 2003/0188043 A1
(43) Pub. Date: Oct. 2, 2003

(54) Two layer middleware architecture with an intermediate target independent interface

(76) Inventors: Thomas R. Woodall, Valencia, CA (US); Mark J. Kuckelman, Long Beach, CA (US)

Correspondence Address: PATENT DOCKET ADMINISTRATION, RAYTHEON SYSTEMS COMPANY, P.O. BOX 902 (E1/E150), BLDG E1 M S E150, EL SEGUNDO, CA, 90245-0902, US

(21) Appl. No.: 10/108,020

(22) Filed: Mar. 27, 2002

(51) Int. Cl. G06F 9/00; G06F 9/46

(52) U.S. Cl. 709/328

(57) ABSTRACT

An innovative middleware architecture for interfacing between a user Application Programming Interface (API) (12) and a target API (16) comprised of two layers with an Intermediate Target Independent Interface (34). This architecture divides the middleware into two separate and distinct layers separated by an Intermediate Target Independent Interface (ITII). The front-end layer (32) maps the user API (12) to the ITII (34), and then the backend layer (36) maps the ITII (34) to the target API (16). In the preferred embodiment, the implementation of each layer would be via a software library, although each library can be divided into sub-libraries. The key feature is the ITII. The ITII defines the fixed interface between the front end of the middleware and the backend of middleware. Each layer will translate between ITII and the other interface while handling various issues associated with that translation. Such issues include initialization, error handling, and programming language differences.

### BACKGROUND OF THE INVENTION

1. Field of the Invention

The present invention relates to computer software programs and architectures. More specifically, the present invention relates to middleware for interfacing between a user application programming interface (API) and a target hardware and/or low-level software API.

2. Description of the Related Art

When users and administrators upgrade hardware and/or low-level software—such as operating systems or device drivers—the application software is also affected. Application programs designed to operate with the Application Programming Interface (API) of the old system generally will not operate properly on the new system without substantial modifications. Changing the application code, however, is undesirable. Application code may include millions of lines of software that would be difficult and expensive to modify.

The current solution is to write a type of software called middleware located between the application program and the operating system to map the old API to the new API. Many new projects being designed today employ middleware as a mechanism to isolate application software from low level software. Middleware is an effective approach to some Diminishing Manufacturing Sources (DMS) problems. Middleware is conventionally designed as a single layer and is tailored specifically for a particular problem. If the low-level software changes (e.g., to a new operating system), then the middleware can be changed without changes to the application software.

However, the low-level change requires a new middleware product, often consisting of a new product or substantially modified product. A new product is often developed because it is more economical than the significant changes generally required.

There are two cultural problems with the existing middleware practice. First, the single layer is generally written for a specific application domain or project. Because the low-level software is known, often specific features, parameters, or behavior of the low-level software leak into the user API. Sometimes this is unintentional, sometimes it is deliberate due to project specific schedule and/or cost constraints. This leakage of low-level specifics into the user API can result in the user API having to change when the low-level software changes. Furthermore, the replacement middleware may contain the same or other types of leaks from the low-level software.

The second problem is that when a new software middleware product is created, it is difficult to hold the software engineers to the existing user API. There are numerous reasons why they might want to change the existing API including programming language considerations, design methodology, design improvements, etc. Even if the software engineers try to preserve the API, the rewrite can result in unintentional semantic differences, even if the syntax (the form of the API) is the same. The existing practice generally requires a significant development effort, even if changes are completely contained within the middleware layer.

Hence, a need exists in the art for an improved middleware architecture that does not require replacement or major modification when the low-level software changes.

### SUMMARY OF THE INVENTION

The need in the art is addressed by the present invention, an innovative middleware architecture for interfacing between a user Application Programming Interface (API) and a target API comprised of two layers with an Intermediate Target Independent Interface between them. This architecture divides the middleware into two separate and distinct layers separated by an Intermediate Target Independent Interface (ITII). The front-end layer maps the user API to the ITII, and then the backend layer maps the ITII to the target API. In the preferred embodiment, the implementation of each layer would be via a software library, although each library can be divided into sub-libraries. The key feature is the ITII. The ITII defines the fixed interface between the front end of the middleware and the backend of middleware. Each layer will translate between ITII and the other interface while handling various issues associated with that translation. Such issues include initialization, error handling, and programming language differences.

### BRIEF DESCRIPTION OF THE DRAWINGS

FIG. 1 shows a block diagram of a system using middleware of conventional design and construction.

FIG. 2 shows a block diagram of a system using two-layer middleware designed in accordance with the teachings of the present invention.

FIG. 3 is a diagram of a complete system using a two-layer middleware designed in accordance with the teachings of the present invention.

FIGS. 4a-4d show examples using the teachings of the present invention.

FIG. 5 is a diagram illustrating how one project using a two-layer middleware can choose among many existing operating systems.

FIG. 6a is a diagram illustrating how an example would be implemented using conventional middleware.

FIG. 6b is a diagram illustrating how an example would be implemented using the middleware architecture of the present invention.

FIG. 6c is a diagram illustrating how a second example would be implemented using the middleware architecture of the present invention.

FIG. 7 is a diagram showing a library structure of two-level middleware in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

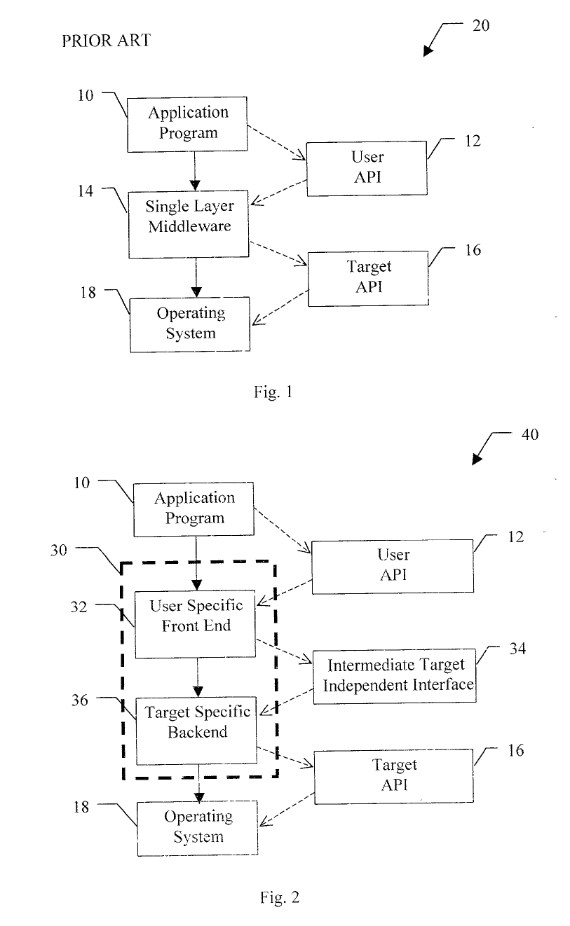

To date, middleware has been developed as one layer, usually as one library. FIG. 1 shows a block diagram of a system 20 using middleware 14 of conventional design and construction. An application 10 using a user specific Application Programming Interface (API) 12 is being run on an operating system 18 with a target specific (e.g., operating system) interface 16. A single layer middleware 14 is placed between the application 10 and the operating system 18 to map the user specific API 12 to the target specific API 16.

The user API 12 is a set of functions or procedures defined by the legacy operating system (i.e.—the operating system for which the application 10 was originally designed to be used) that can be called by the application 10. The application 10 continues to use the functions from the user API 12, but the target operating system 18 does not understand these functions. It instead uses functions from its own API 16. The target API 16 is a set of functions or procedures defined by the target operating system 18 which allow application programs to interface with its system. The middleware 14 acts as an interface between the application 10 and the operating system 18 by defining the functions from the user API 12 using functions from the target API 16. The application 10 can then be run on the target operating system 18.

The present invention is an innovative middleware architecture comprised of two layers with an Intermediate Target Independent Interface. This architecture divides the middleware into two separate and distinct layers separated by an intermediate target independent interface (ITII). In the preferred embodiment, the implementation of each layer would be via a software library, although each library can be divided into sub-libraries (highly desirable). The key feature is the ITII. The ITII defines the fixed interface between the front end of the middleware and the backend of middleware. Each layer will translate between ITII and the other interface while handling various issues associated with that translation. Such issues include initialization, error handling, and programming language differences.

FIG. 2 shows a block diagram of a system 40 using a two-layer middleware 30 designed in accordance with the teachings of the present invention. An application 10 using a user specific Application Programming Interface 12 is being run on an operating system 18 with a target specific (e.g., operating system) interface 16. A two-layer middleware 30 comprised of a user specific front end 32 and a target specific backend 36 is placed between the application 10 and the operating system 18. The middleware front end 32 maps the user specific API 12 to an Intermediate Target Independent Interface (ITII) 34. The middleware backend 36 then maps the ITII 34 to the target specific API 16. The front end 32 handles user (i.e., application program) specific services and service parameters, such as user-specific programming language issues, error handling issues, and initialization issues. This includes translating data and status and properly passing that back to the user. The backend 26 handles target specific (e.g., operating system) services and service parameters, such as target specific programming language issues, error handling issues, and initialization issues. This includes translating data and status and properly passing that back to the ITII.

The Intermediate Target Independent Interface 34 is a generic or target independent set of functions or procedures predefined by the manufacturer or middleware designer. Instead of translating directly from the user API 12 to the target API 16 as in the prior art, the present invention uses a middleware front end 32 to define the functions from the user API 12 using functions from the ITII 34, and then a middleware backend 36 defines the functions from the ITII 34 using functions from the target API 16.

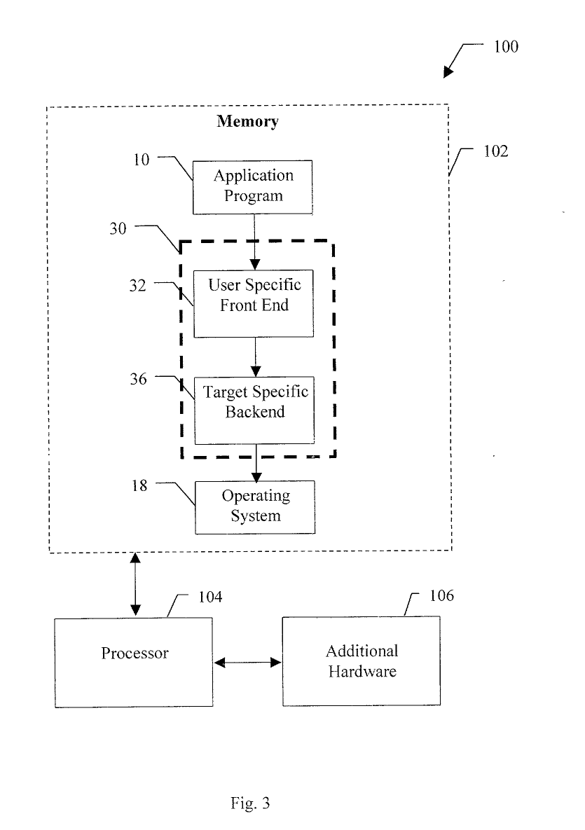

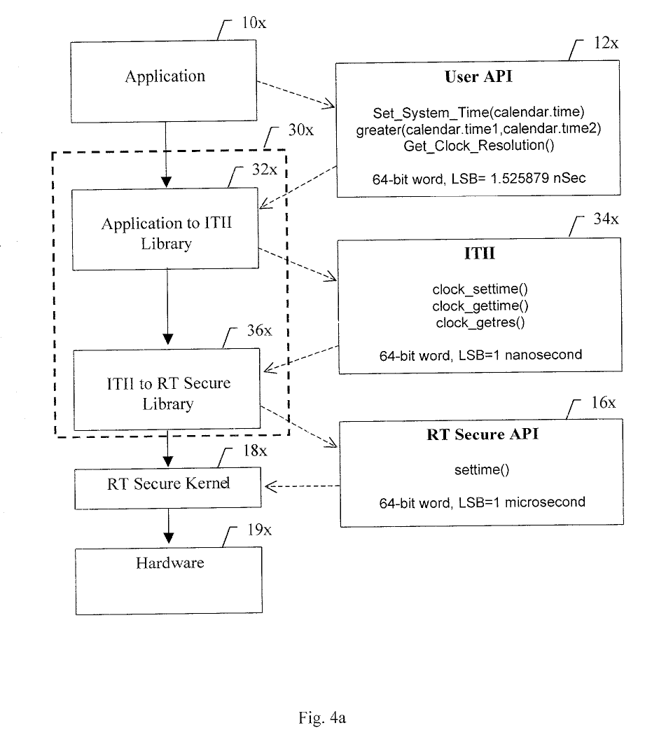

FIG. 3 is a diagram of a complete system 100 using a two-layer middleware 30 designed in accordance with the teachings of the present invention. As depicted in FIG. 3, an application 10 using a user specific Application Programming Interface 12 executes on an operating system 18 with a target specific interface 16. Two-layer middleware 30 comprised of a user specific front end 32 and a target specific backend 36 is placed between the application 10 and the operating system 18. The application 10, middleware 30, and operating system 18 are all implemented in software residing in memory 102 and executed by a processor 104. The system may also include additional hardware 106.

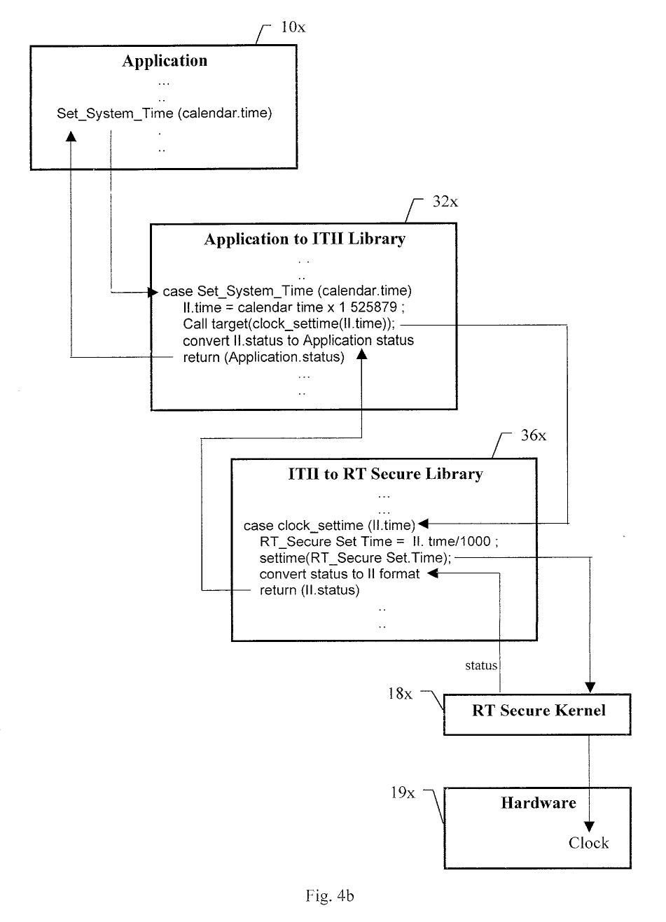

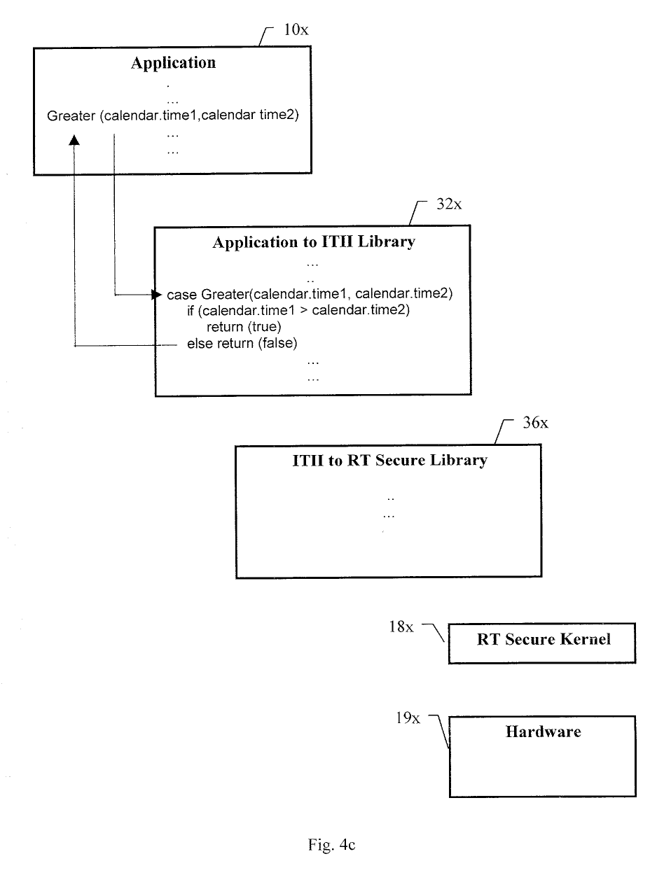

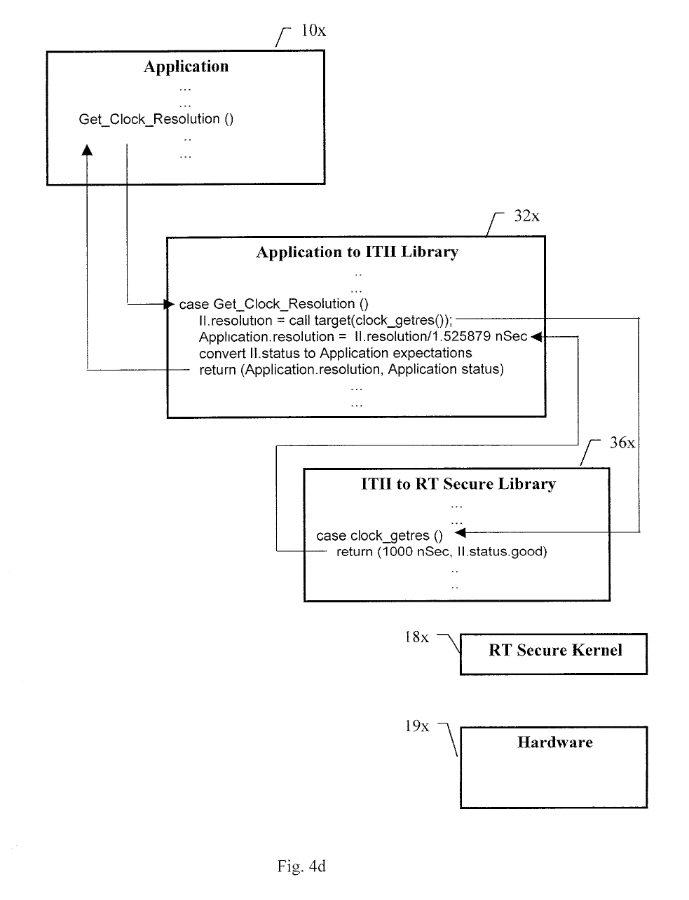

FIGS. 4a-4d show examples using the teachings of the present invention. FIG. 4a is a diagram showing an exemplary system using the teachings of the present invention. In FIG. 4a, an application 10x using a user API 12x is being run on the RT Secure Operating System 18x and hardware 19x by using a two layer middleware 30x which includes a front end library (Application to ITII) 32x and a backend library (ITII to RT Secure) 36x. The user API 12x includes the functions Set_System_Time(calendar.time), Greater(calendar.time1, calendar.time2), and Get_Clock_Resolution( ), among others. The user API 12x assumes a 64-bit word with a least significant bit (LSB) of 1.525879 nSec. The middleware front end 32x translates functions from the user API 12x to an ITII 34x. The ITII 34x includes the functions clock_settime( ), clock_gettime( ), and clock_getres( ). The ITII 34x assumes a 64-bit word with a LSB of 1 nanosecond. The middleware backend 36x translates from the ITII 34x to the RT Secure API 16x. The RT Secure API 16x includes a function settime( ), and uses a 64-bit word with a LSB of 1 microsecond. In the examples, the middleware front-end library 32x and the middleware backend library 36x are both written using the C programming language.

FIG. 4b is a diagram showing the “Set_SystemTime” example. In the user API 12x (shown in FIG. 4a), this function sets the system clock to the parameter calendar.time, which is given with a LSB of 1.525879 nSec. The middleware front end 32x includes the following subroutine:

case Set_System_Time (calendar.time)

II.time=calendar.time×1.525879;

Call target(clock_settime(II.time));

convert II.status to Application status

return (Application.status)

When the application 10x calls the function Set_System_Time from the user API 12x, the middleware front end 32x runs this subroutine. First, the parameter calendar.time is converted to the ITII format. Then, the middleware front end 32x calls the ITII function “clock_settime” which is defined in the middleware backend 36x for the operating system RT Secure 18x.

The middleware backend 36x defines the ITII function “clock_settime” with the following subroutine:

case clock_settime (II.time)

RT_Secure.Set.Time = II. time/1000;

settime(RT_Secure.Set.Time);

convert status to II format

return (II.status)

The parameter II.time is converted to RT Secure format. The middleware backend 36x calls the RT Secure function “settime” which accesses the hardware 19x and sets the system clock. The operating system RT Secure 18x returns a status to the middleware backend 36x, which converts the status to ITII format and sends it to the middleware front end 32x. The middleware front end 32x converts the status to the application format and returns it to the application 10x.

FIG. 4c is a diagram showing the “Greater” example. In the user API 12x (shown in FIG. 4a), this function compares two time parameters calendar.time1 and calendar.time2, which are given with a LSB of 1.525879 nSec, and returns true if the left parameter is greater than the right parameter. The middleware front end 32x includes the following subroutine:

case Greater(calendar.time1, calendar.time2)

if (calendar.time1>calendar.time2)

return (true)

else return (false)

When the application 10x calls the function Greater from the user API 12x, the middleware front end 32x runs this subroutine and sends a return to the application 10x. In this example, no call to the middleware backend 36x is necessary.

FIG. 4d is a diagram showing the “Get_Clock_Resolution” example. In the user API 12x (shown in FIG. 4a), this function returns the clock resolution. The middleware front end 32x includes the following subroutine:

case Get_Clock_Resolution ( )

II.resolution=call target(clock_getres( ));

Application.resolution = II.resolution/1.525879 nSec

convert II.status to Application expectations

return (Application.resolution, Application.status)

When the application 10x calls the function Get_Clock_Resolution from the user API 12x, the middleware front end 32x runs this subroutine. First, it calls the ITII function “clock_getres” which is defined in the middleware backend 36x.

The middleware backend 36x defines the ITII function “clock_getres” with the following subroutine:

case clock_getres ( )

return (1000 nSec, II.status.good)

This subroutine returns the RT Secure clock resolution (1000 nSec) and an ITII format status to the middleware front end 32x. The middleware front end 32x converts the clock resolution and status to application format and returns them to the application 10x. In this example, no call to the operating system 18x or hardware 19x is necessary. If RT Secure does not offer a specific service (such as clock_getres), identical functionality can be provided within the backend library 36x.

As illustrated by these examples, the middleware front end 32 provides translation services from legacy APIs to an ITII that consists of generic services (in the examples these services are POSIX-based). In addition, the front end 32 returns status information to the legacy application in the appropriate format, after converting it from the generic ITII format. The front end 32 also provides services that are non-target specific, such as math functions, format conversions, big endian to little endian translations, and resolving other target-based incompatibilities.

The middleware backend 36 translates generic ITII services into target-specific commands, provides target-specific services that may or may not access the target operating system and/or hardware, and returns data/status in the ITII format.

The two layer middleware architecture with an Intermediate Target Independent Interface reduces or eliminates changes due to low level software modifications. Furthermore, it addresses both of the cultural problems addressed in the previous section. It does so, because it is modular.

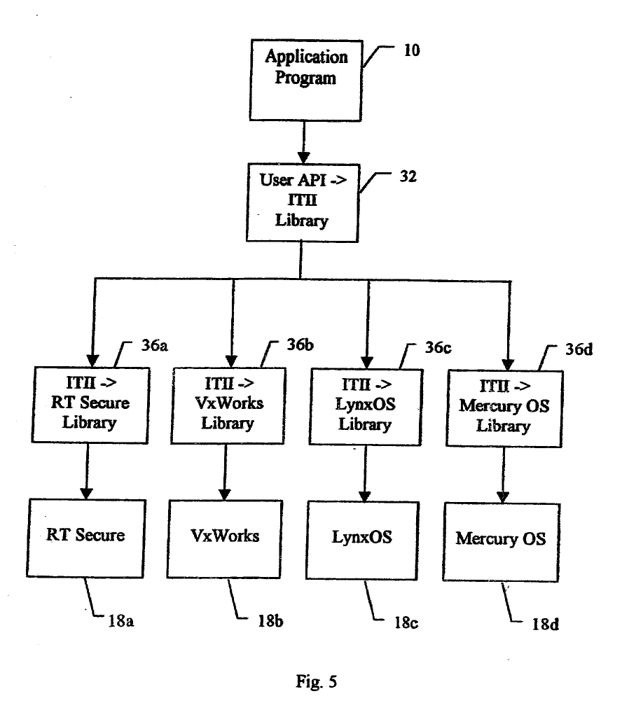

FIG. 5 is a diagram illustrating how one project using a two-layer middleware can choose among many existing operating systems. An application 10 uses a middleware front end 32 to map its user API 12 (not shown) to an Intermediate Target Independent Interface 34 (not shown). This one front end 32 can be used with several different backends. For example, it can use a middleware backend 36a that maps the ITII to the RT Secure operating system interface, allowing the application 10 to be run on a RT Secure operating system 18a. Alternatively, the same front end 32 can be At . used with a middleware backend 36b which maps the ITII to the VxWorks interface, allowing the application 10 to be run on a VxWorks operating system 18b. Similarly, the front end 32 can be used with backends 36c or 36d which map the ITII to the LynxOS interface and the Mercury OS interface, respectively, allowing the application 10 to be run on a LynxOS 18c or Mercury OS 18d operating system, respectively.

If middleware backends have already been developed for these operating systems (as would be the case if the operating systems have been used in other projects using the two layer middleware architecture with the ITII), then no further middleware development is required to use any of those operating systems beyond the single middleware front end. In contrast, with the single layer middleware architecture of the prior art, a new middleware must be custom designed for each operating system an application will be using.

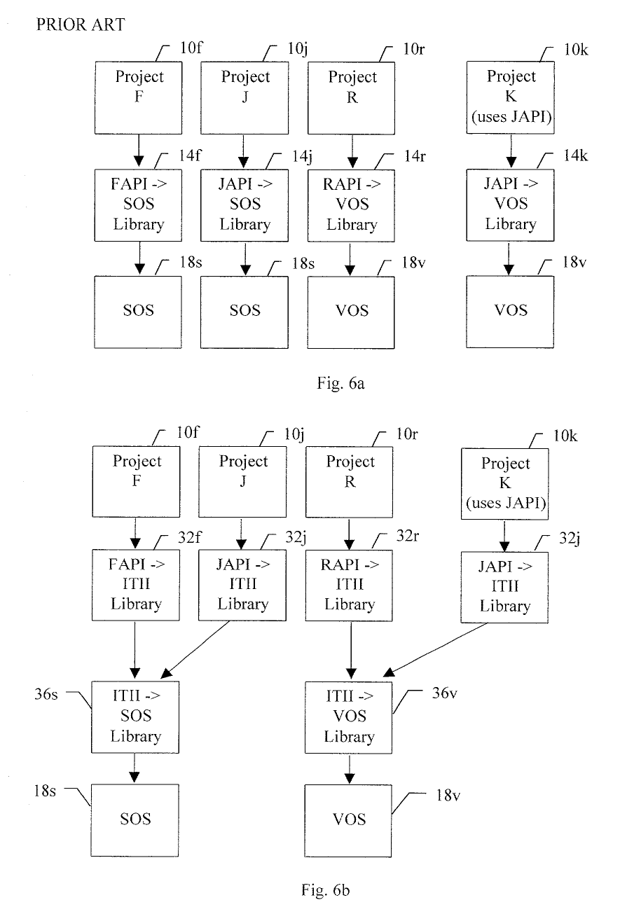

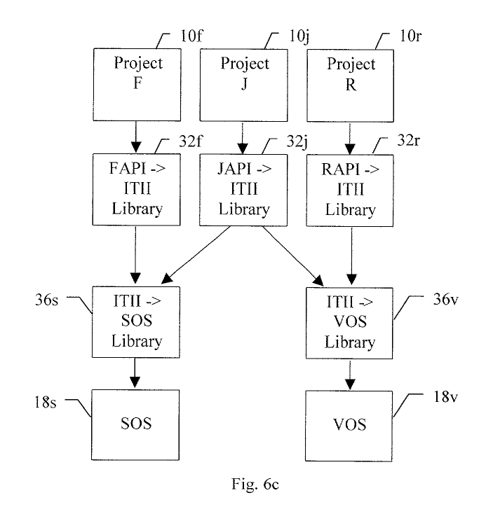

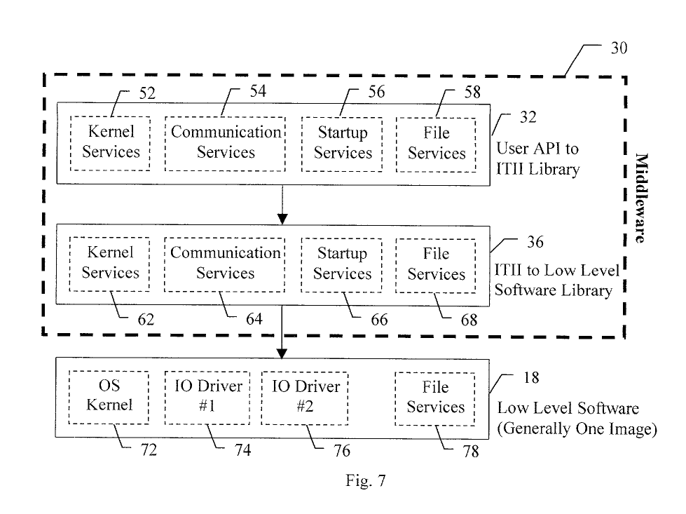

The competitive advantage of this middleware architecture is cost savings across multiple projects. The following example illustrates this. Suppose there are three projects (F, J, and R) each of which has a project specific API (FAPI, JAPI, and RAPI, respectively). Project F 10f, Project J 10j, and Project R 10r each have application programs that use operating systems SOS 18s, SOS 18s, and VOS 18v, respectively. FIG. 6a is a diagram illustrating how this example would be implemented using conventional middleware. With the standard single layer middleware architecture, there are 3 different middleware products (14f, 14j, and 14r): one each for mapping FAPI to SOS 14f, JAPI to SOS 14j, and RAPI to VOS 14r. FIG. 6b is a diagram illustrating how this example would be implemented using the middleware architecture of the present invention. With the two-layer middleware architecture there are three front ends (FAPI to ITII 32f, JAPI to ITII 32j, and RAPI to ITII 32r) and two backends (ITII to SOS 36s and ITII to VOS 36v). This might represent some development savings.

The real savings come as new projects emerge or existing projects change. For example, lets assume a new project comes along, called Project K 10k, that plans on using the software from Project J but plans on using a computer similar to Project R and thus will use the VOS 18v. This can easily be done by using the front end of Project J (JAPI to ITII 32j) with the backend for the VOS (ITII to VOS 36v). The middleware product to be used is formed from the existing libraries—in other words, there is no middleware development effort. With the prior art approach, a new middleware product 14k that maps JAPI to VOS would need to be developed.

In another scenario, assume that the SOS supplier goes out of business and Project J 10j decides to use the VOS 18v. FIG. 6c is a diagram illustrating how this example would be implemented using the middleware architecture of the present invention. Project J 10j can use both the SOS 18s and the VOS 18v with no middleware development by using the ITII->VOS library 36v.

As a final example, assume Project R needs to change to a new operating system, NOS, where there is no ITII->NOS library. They can then generate this library. Because the ITII is so well defined, they will not change it. If the NOS provides services that are desired that don't correlate to existing services, then the ITII can be added to, leaving all existing interfaces as is. No other front ends will have to change to use those services.

In general, if there are m number of user APIs and n number of operating systems, there is a total of m×n number of combinations of user API to operating system. With the old single layer middleware architecture, m×n number of middleware products would need to be developed in order to realize all of the combinations, one for each combination. With the new two layer middleware architecture, only m+n number of middleware products would need to be developed to realize all of the m×n combinations, m front end middleware products and n backend middleware products. This has the potential to greatly reduce costs associated with development, maintenance, and deployment of middleware products.

The cultural problems associated with changes in middleware are avoided or mitigated because either an existing backend can be used (Project K example) or only a backend will change (NOS example), which may or may not require an ITII change. Furthermore, this Two Layer Middleware Architecture with an Intermediate Target Independent Interface will help push projects to use existing libraries, resulting in schedule and cost savings.

In the preferred embodiment, the implementation of the two-layer middleware architecture should be through two separate and distinct software libraries. FIG. 7 is a diagram showing a simple library structure of two level middleware in accordance with the teachings of the present invention. The middleware 30 is comprised of two libraries. The first library 32 is the User API to ITII library. In the illustrative example, the first library 32 includes modules for Kernel Services 52, Communication Services 54, Startup Services 56, and File Services 58. The second library 36 is the ITII to Low Level Software Library. In the illustrative example, the second library 36 includes modules for Kernel Services 62, Communication Services 64, Startup Services 66, and File Services 68. The second library 36 maps to low-level software 18, which in the illustrative example include an Operating System Kernel 72, a first Input/Output Device Driver 74, a second Input/Output Device Driver 76, and File Services 78.

The structure of the library should be flexible, particularly the ITII to Low Level Software Library, as it will desirable to have that library be made up of different software modules. For example one module might be for the operating system while another is for device drivers. Of course, there might be more than one device driver. Furthermore, there will be a strong correspondence between modules in the two libraries in that each might have a module for kernel services and communication. However, the modules in the second library may have little or no correlation to the number or types of modules that make up the low level software. It should be this way since the low level software is not under control of the middleware developer; however, in come case—like operating system kernel services—there will be some correspondence.

As different User APIs are written to the ITII and as more ITII to Low Level Software Libraries are written, there will become two sets of libraries. These two sets will allow different users to easily mix and match libraries to easily accommodate changes in commercial low level software. New users will be able to select from a large base of existing user software, confident that it can be affordably mapped to their system. Both of the scenarios will provide a tremendous competitive advantage.

The Intermediate Target Independent Interface is the critical element in the two layer middleware architecture. The ITII provides the separation from the user API and the portability from one operating system to another. Without an ITII, any middleware is specific both to the user and the target (thus reinvented for every project).

The user API presents a generally limited view of the ITII tailored to the user/project needs. The ITII is a combined view of the implemented operating system APIs, but maintains an implementation that allows for extensibility to various operating system APIs.

The ITII needs to provide access to any services that are intended to be used. Not all services need to be implemented but the ITII needs to address the future use of services not implemented to date. The ITII, as a necessity, needs to be—in many ways—a common denominator. This requires it to be simple and to use implementation approaches that, while not “perfect”, enable optimal target independence. Some key suggested approaches include using a C Language ITII, using the described library approach, and separating procedural and object oriented services.

In addition to providing API service calls in the traditional sense, it may be acceptable, in some cases, to just return good status in the front end or backend libraries, without performing the service requested by the API call. There are a number of situations where this might be acceptable. An example is an API call to perform a security function that is not available on the target system. The back-end library might service the API by just returning a good status, although no security check was actually performed. This situation might be acceptable to a customer who feels the legacy security threat is no longer worth attention. Most such cases should be handled in the back end. The only time when this might be handled in the front end is when there is no ITII service available and the definition of one would be contrived, or where the developer feels that at the present time there is not a common denominator, e.g., where technology is rapidly developing but without clear direction on what the good approach may be until later.

For some domains there may be some legacy functions that would need heavy modification in order to have meaning in a new environment. A good example of this would be security functions migrated from a secure operating system environment (e.g., RT Secure) to a non-secure operating system environment (e.g., VxWorks). While it might be good enough (acceptable to some users and/or customers) to allow these functions to be simply rubber-stamped with the dummy responses (as described above), other users and/or customers may require that this security functionality be maintained during the re-host effort. In the context of this invention, the best approach for maintaining legacy functionality that is not available in the target system is that such functionality be embedded in the back-end library. If the front end handled this functionality, another future target change that provided the desired functions would require a front end change plus using a new backend, whereas if the back end handles it then the future system only requires a back end change.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A program for interfacing between a user Application Programming Interface (API) and a target API comprising:
first means for interfacing between said user API and an intermediate target independent interface (ITII) and
second means for interfacing between said ITII and said target API.

2. The invention of claim 1 wherein said intermediate target independent interface is a set of generic functions or procedures.

3. The invention of claim 2 wherein said first means defines functions from said user API using functions from said ITII.

4. The invention of claim 2 wherein said second means defines functions from said ITII using functions from said target API.

5. The invention of claim 1 wherein said first means is a front-end library of software functions.

6. The invention of claim 1 wherein said second means is a backend library of software functions.

7. The invention of claim 5 wherein said front-end library includes multiple sub-libraries or modules.

8. The invention of claim 7 wherein said front end library may completely satisfy the API call, without any interaction with the backend library or target API.

9. The invention of claim 6 wherein said back-end library includes multiple sub-libraries or modules.

10. The invention of claim 9 wherein said backend library may completely satisfy the API call, without any interaction with the target API.

11. The invention of claim 1 wherein said target API includes an operating system API.

12. The invention of claim 1 wherein said target API includes a hardware interface.

13. The invention of claim 1 wherein said target API includes low-level software API.

14. A system for running a legacy software application on a target operating system comprising:
a processor;
memory;
a software application utilizing a user Application Programming Interface (API);
an operating system utilizing a target API; and
a two layer middleware for interfacing between said application and said operating system wherein said two layer middleware includes:
a first program for interfacing between said user API and an intermediate target independent interface (ITII), and
a second program for interfacing between said ITII and said target API,
wherein said application, operating system, and two layer middleware are implemented in software residing in said memory and executed by said processor.

15. A method for interfacing between a user Application Programming Interface (API) and a target API including the steps of:
interfacing between said user API and an intermediate target independent interface (ITII) and
interfacing between said ITII and said target API.
